(19) United States
(12) Patent Application Publication
(10) Pub. No.: US 2009/0045302 A1
(43) Pub. Date: Feb. 19, 2009

(54) Method of Manufacture and Utilization of Portable Utility Pole Standards

(76) Inventor: Glenn Ray Langley, Magnolia, AR (US)

Correspondence Address: JAMES M. VAN BUSKIRK, 2805 EAAST DENALI DRIVE, DEER PARK, TX, 77536, US

(21) Appl. No.: 11/838,868

(22) Filed: Aug. 14, 2007

(51) Int. Cl. F16M 11/00

(52) U.S. Cl. 248/125.8

(57) ABSTRACT

A support system that is portable. The support is made up of two pieces of tubular steel where one is smaller and can fit inside the other. While in this condition the steel pieces are held together by a nut and bolt that are placed through a hole on one end of the tubes. There is a square hole machined on the other end of the large tube and perpendicular to the first hole. This hole allows the smaller to tube to fit in perpendicular to the large tube. To complete the assembly the two tubes are held in place by the same nut and bolt. There is a piece of angle iron welded on the large tube, at the same end and parallel to the square hole. One unit will have two support assemblies held together with a chain and clevis system. The final product will use two units placed at either end of a set of horizontal utility poles to keep them in place during storms or high winds.

### BACKGROUND FOR THE INVENTION

The invention is considered to be a collapsible and portable support to contain spare utility pole standards that are laid on the ground horizontally.

### BRIEF SUMMARY OF THE INVENTION

The device is a collapsible stand made of two different sizes of tubular steel; one capable of fitting into the other as seen in FIG. 3. The smaller tube can be removed from the larger tube making an angle as seen in FIG. 4. Two identical units are attached by a chain and clevis system making a unit. Two units are placed at opposite ends of a horizontal stack of utility poles. The stands will keep the utility poles from moving during winds and storms.

### BRIEF SUMMARY OF THE DRAWINGS

FIG. 1 is a plan view of a single unit showing it put together for use.

FIG. 2 shows the three individual parts separated.

FIG. 3 Show the unit in its collapsed and portable position.

FIG. 4 shows two assemblies held together by a clevis and chain system making a unit.

FIG. 5 shows an enlarged segment from FIG. 1 showing how the small tube fits into a hole in the large tube and is held by a nut and nut.

FIG. 6 shows an enlarged view from FIG. 4 showing how the clevis is attached to the assembly.

### DETAILED DESCRIPTION OF THE INVENTION

The device is used to keep spare utility poles that are being stored in a horizontal position from moving during storms and high winds. As shown in the collapsed assembly, FIG. 3, (7) fits inside (4) and is held there by (1) and (2) that fit through (5) farthest from (3) a piece of angle iron. As shown in FIG. 5 the angle iron (3) is welded to (4) at the same end as hole (6) and parallel to hole (6). The angle iron (3) supports the standard when its assembled.

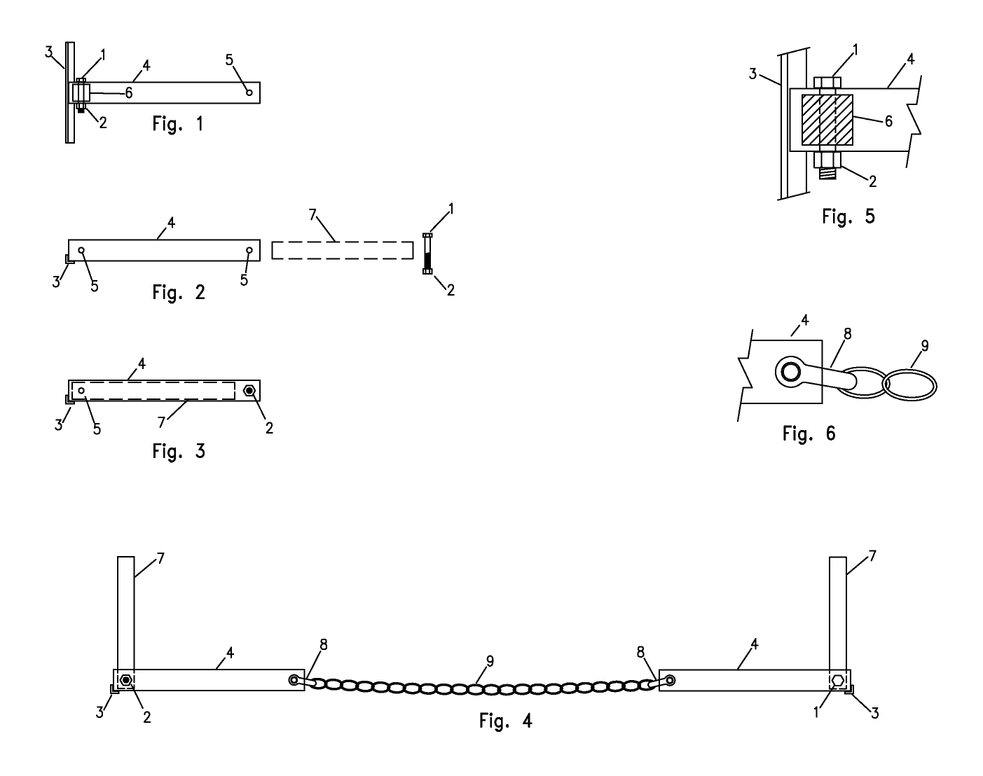

FIG. 2 shows the individual pieces (2), (4) and (7) in the broken down condition. FIG. 1 shows the support assembled. Square tube (7) fits into square hole (6) and held in place by nut (1) and nut (2) that go through round hole (5) closest to angle iron (3). Three more assemblies are needed to complete the final product.

Two assemblies are held together with a chain (9) and a clevis (8) system comprising a unit. The clevis fits through the now unoccupied hole number (5) farthest from angle iron (3). A complete unit is shown in FIG. 4. Two units are placed at either end of a vertically stacked plurality of utility poles to make the final product.

In the design of the invention, the inventor used 2½″× 3/16″×30″ long tubing for (4), 2″× 3/16″×28″ tubing long for (7), ½″ nut for (1), ½″ nut for (2), 1″ angle iron, 12″ long for (3) and a ⅜″ clevis for (8). Dimensions can vary depending on size needed, but these dimensions should work for most situations.

What is claimed:

1. A portable support stand comprised of two pieces of tubular steel, one that fits inside the other with the two pieces being held together with a nut and bolt. A square hole is machined into one end of the larger tube that will allow the smaller tube to fit inside it. There is a piece of angle iron welded to the larger tube and running parallel with the square hole to support the completed assembly. The support is assembled by removing the nut and bolt, taking the small tube out of the big tube, placing the small tube in the square hole and putting the nut and bolt back through the larger tube and small tube.

2.
a. Same as claim 1 with two assembled supports tied together with a chain and clevis system making a unit.
b. The final assembly uses two units placed at opposite ends of vertically stacked horizontal utility poles to hold them in place.
